(19) United States
(12) Patent Application Publication
(10) Pub. No.: US 2026/0368662 A1
(43) Pub. Date: Nov. 19, 2026

(54) JOB SHOP SCHEDULING OPTIMIZATION METHOD DRIVEN BY MULTI-MODAL LARGE-MODEL COLLABORATION, APPARATUS AND DEVICE

(71) Applicant: Huazhong University of Science and Technology, Hubei (CN)

(72) Inventors: Xinyu Li, Hubei (CN); Jie Yang, Hubei (CN); Liang Gao, Hubei (CN); Qihao Liu, Hubei (CN); Jin Huang, Hubei (CN)

(73) Assignee: Huazhong University of Science and Technology, Hubei (CN)

(21) Appl. No.: 19/348,752

(22) Filed: Oct. 2, 2025

(30) Foreign Application Priority Data
May 15, 2025 (CN) 202510625365.1

(51) Int. Cl. G06Q 10/0631; G06F 40/40; G06T 3/40; G06T 5/80; G06T 7/11; G06V 10/70; G06V 20/62

(52) U.S. Cl. CPC G06Q 10/06312; G06F 40/40; G06Q 10/06315; G06T 3/40; G06T 5/80; G06T 7/11; G06V 10/70; G06V 20/63

(57) ABSTRACT

The present application discloses a job shop scheduling optimization method driven by multi-modal large-model collaboration, which includes: acquiring a job shop scheduling problem image and a job shop scheduling problem text, and preprocessing the job shop scheduling problem image to enhance semantic information therein; inputting the job shop scheduling problem image and a corresponding text description into a multi-modal large model to acquire a structured constraint description of a problem, performing reverse checking on the structured constraint description of the problem, and inputting, after passing the check, the structured constraint description of the problem and the job shop scheduling problem text into a first large model to acquire a complete constraint description; and inputting the complete constraint description into a second large model to construct a model code for the complete constraint description, and solving the problem for the generated model code to acquire a scheduling solution.

### CROSS-REFERENCE TO RELATED APPLICATION

This application claims the priority benefit of China application serial no. 202510625365.1, filed on May 15, 2025. The entirety of the above-mentioned patent application is hereby incorporated by reference herein and made a part of this specification.

### BACKGROUND

### Technical Field

The present application relates to the technical field of modeling and solving, and in particular, to a job shop scheduling optimization method driven by multi-modal large-model collaboration.

### Description of Related Art

With the accelerated intelligent transformation of the global manufacturing industry, job shop scheduling optimization has become a core technology for enhancing production efficiency and reducing operational costs. Under this context, job shop scheduling technology needs to overcome critical bottlenecks such as multi-constraint collaboration, multi-modal fusion, and real-time responsiveness to meet the high-efficiency scheduling demands of complex industrial scenarios. The general steps for modern job shop scheduling solutions involve: first extracting constraint information from actual job shops, then developing intelligent algorithms based on the constraints, and finally programming according to the algorithms to acquire a scheduling solution. In recent years, breakthroughs in generative large model technology have provided a new paradigm for job shop scheduling optimization. Multi-modal large models, represented by GPT-4o and Gemini, have demonstrated powerful capabilities in text understanding, image parsing, and code generation, offering a new pathway for semantic extraction and modeling of unstructured information in industrial scenarios. By using non-specialized textual descriptions and drawing basic logical diagrams to illustrate the relationships among job shop scheduling constraints, workers can, with the help of large models’ text-image comprehension capabilities, achieve standardized descriptions of job shop constraint semantics.

However, existing technologies are mostly limited to single-modality processing. The current operations research optimization methods based on large language models utilize large model prompting methods that fail to consider the semantic comprehension of image information, such as images and diagrams. Sole reliance on textual information can easily lead to deviations in the large model’s understanding of user intent. Using a single large model to generate scheduling code lacks a dynamic multi-agent collaborative mechanism, making it difficult to address diverse requirements in the scheduling optimization process, such as constraint description, code generation, and code verification. Moreover, multiple rounds of large model invocation may result in excessive solution time and wasted computing resources.

### SUMMARY

To address at least one defect or improvement need in the prior art, the present disclosure provides a job shop scheduling optimization method driven by multi-modal large-model collaboration, capable of solving at least one of the problems described in the background section.

To achieve the above objective, according to a first aspect of the present disclosure, a job shop scheduling optimization method driven by multi-modal large-model collaboration is provided. The method includes:
acquiring a job shop scheduling problem image and a job shop scheduling problem text, and preprocessing the job shop scheduling problem image to enhance semantic information therein;
inputting the job shop scheduling problem image and a corresponding text description into a multi-modal large model to acquire a structured constraint description of a problem, performing reverse checking on the structured constraint description of the problem, and inputting, after passing the check, the structured constraint description of the problem and the job shop scheduling problem text into a first large model to acquire a complete constraint description; and
inputting the complete constraint description into a second large model to construct a model code for the complete constraint description, and solving a problem for the generated model code to acquire a scheduling solution.

Furthermore, according to the job shop scheduling optimization method driven by multi-modal large-model collaboration, inputting the complete constraint description into the second large model to construct the model code for the complete constraint description, and solving the problem for the generated model code specifically includes:
inputting, based on a preset basic format requirement for code generation, the complete constraint description into the second large model to generate the model code, where the preset basic format requirement for code generation includes automatically selecting an objective function template based on a specified solver type and modeling language, function naming, and a variable definition method;
storing the generated model code into a preset program file, and preliminarily solving the model code based on preset job shop information and standardized data; and
automatically optimizing solver parameters by enabling parallel computation, a heuristic strategy, or by setting a time limit or a feasible solution threshold.

Furthermore, according to the job shop scheduling optimization method driven by multi-modal large-model collaboration, after constructing the model code for the complete constraint description, the method further includes:
performing a feasibility check on the model code based on a third large model, providing, if the model code is unable to run properly, an error cause and a repair suggestion based on error information, inputting the error cause and the repair suggestion into the second large model, and reconstructing the model code for the complete constraint description until the model code runs properly.

Furthermore, according to the job shop scheduling optimization method driven by multi-modal large-model collaboration, after solving the problem for the generated model code, the method further includes:
inputting a solved result into a fourth large model for verification, performing reverse tracing for a detected anomaly to map an anomalous conflict node back to an original structured constraint description, locating a constraint logic flaw, optimizing constraint information, and reacquiring the structured constraint description of the problem.

Furthermore, according to the job shop scheduling optimization method driven by multi-modal large-model collaboration, preprocessing the job shop scheduling problem image specifically includes:
correcting a geometric shape of the acquired job shop scheduling problem image based on perspective transformation or thin-plate spline interpolation to restore a basic structure of the image;
locating a text region by using an EAST (efficient and accurate scene text detector) model, enhancing resolution of a detected text region separately, and removing interference around the text through a binarization method or color masking; and
segmenting image regions based on a segmentation model, and performing differentiated enhancement on the segmented regions.

Furthermore, according to the job shop scheduling optimization method driven by multi-modal large-model collaboration, performing the reverse checking on the structured constraint description of the problem specifically includes:
inputting the structured constraint description of the problem into the multi-modal large model, generating code for drawing a job shop scheduling problem image based on the structured constraint description of the problem, running the code to acquire a new job shop scheduling problem image, comparing structural similarity and information accuracy between the job shop scheduling problem image and the new job shop scheduling problem image, initiating an incremental prompt adjustment based on a comparison result, adding a failure reason description to the structured constraint description of the problem, and re-inputting the structured constraint description into the multi-modal large model.

Furthermore, according to the job shop scheduling optimization method driven by multi-modal large-model collaboration, after preprocessing the job shop scheduling problem image, the method further includes:
when there are a plurality of job shop scheduling problem images, understanding the plurality of job shop scheduling problem images and corresponding text descriptions based on the multi-modal large model, identifying and removing redundant constraints and conflicting constraints, and then outputting a structured constraint description of the problem.

According to a second aspect of the present disclosure, a job shop scheduling optimization apparatus driven by multi-modal large-model collaboration is further provided. The apparatus includes:
a multi-modal information processing unit, configured to acquire a job shop scheduling problem image and a job shop scheduling problem text and preprocess the job shop scheduling problem image to enhance semantic information therein;
a constraint generation unit, configured to input the job shop scheduling problem image and a corresponding text description into a multi-modal large model to acquire a structured constraint description of a problem, perform reverse checking on the structured constraint description of the problem, and input, after passing the check, the structured constraint description of the problem and the job shop scheduling problem text into a first large model to acquire a complete constraint description; and
a code generation and solving unit, configured to input the complete constraint description into a second large model to construct a model code for the complete constraint description and solve the problem for the generated model code to acquire a scheduling solution.

According to a third aspect of the present disclosure, a job shop scheduling optimization device driven by multi-modal large-model collaboration is further provided. The device includes at least one processing unit and at least one storage unit, where the storage unit stores a computer program, and the computer program, when run by the processing unit, causes the processing unit to perform the steps of any one of the methods described above.

According to a fourth aspect of the present disclosure, a storage medium is further provided, which stores a computer program executable by a job shop scheduling optimization device driven by multi-modal large-model collaboration. The computer program, when running on the job shop scheduling optimization device driven by multi-modal large-model collaboration, causes the job shop scheduling optimization device driven by multi-modal large-model collaboration to perform the steps of any one of the methods described above.

In general, compared to the prior art, the above technical solutions contemplated by the present disclosure can achieve the following beneficial effects:
According to the job shop scheduling optimization method driven by multi-modal large-model collaboration provided by the present disclosure, the semantic information in images can be enhanced and the accuracy of constraint extraction can be improved through multi-modal information input and preprocessing. The collaborative processing of multi-modal large models can effectively generate clear and complete constraint descriptions while reducing constraint conflicts and redundancies. By using a multi-agent architecture and based on the division of labor and collaboration among different large models, efficient collaboration can be achieved, ranging from constraint generation to code construction and solution solving, thereby significantly improving the optimization efficiency and reliability of the scheduling solution. Meanwhile, the combination of reverse checking and a domain knowledge base verification mechanism can ensure the feasibility and global optimality of the scheduling solution.

### BRIEF DESCRIPTION OF THE DRAWINGS

To more clearly illustrate the technical solutions in the embodiments of the present application, a brief introduction to the accompanying drawings required for the embodiments is provided below. It is evident that the accompanying drawings described below pertain only to some embodiments of the present application, and for those of ordinary skill in the art, other drawings can be derived from these accompanying drawings without creative efforts.

FIG. 1 is a schematic flowchart of a job shop scheduling optimization method driven by multi-modal large-model collaboration according to an embodiment of the present application.

FIG. 2 is a schematic diagram illustrating a process of acquiring a complete constraint description according to an embodiment of the present application.

FIG. 3 is a schematic diagram illustrating the processing of multi-modal information across multiple diagrams according to an embodiment of the present application.

FIG. 4 is a schematic diagram of a constraint extraction prompt of a scheduling process relationship diagram according to an embodiment of the present application.

FIG. 5 is a schematic diagram of a prompt during a code generation phase according to an embodiment of the present application.

FIG. 6 is a schematic diagram of a prompt for code checking and feedback according to an embodiment of the present application.

FIG. 7 is a schematic diagram of multi-modal information input according to an embodiment of the present application.

FIG. 8 is a schematic diagram of all structured constraint information of a job shop scheduling problem according to an embodiment of the present application.

FIG. 9 is a schematic structural diagram of a job shop scheduling optimization apparatus driven by multi-modal large-model collaboration according to an embodiment of the present application.

FIG. 10 is a schematic structural diagram of a job shop scheduling optimization system driven by multi-modal large-model collaboration according to an embodiment of the present application.

### DESCRIPTION OF THE EMBODIMENTS

In order to make the objectives, technical solutions, and advantages of the present disclosure clearer, the present disclosure is further described in detail below with reference to the accompanying drawings and embodiments. It should be understood that the specific embodiments described herein are merely illustrative of the present disclosure and are not intended to limit the present disclosure. In addition, the technical features described below in the embodiments of the present disclosure can be combined with each other as long as they do not conflict with each other.

The terms “first”, “second”, “third”, “fourth”, etc., in the specification and claims of the present application and the accompanying drawings are defined to distinguish different objects and are not intended to describe a specific order. In addition, the terms “include” and “have” and any variations thereof are intended to cover non-exclusive inclusion. For example, a process, method, system, product, or device that includes a series of steps or units is not limited to the steps or units listed but may optionally include steps or units not listed, or may optionally include other steps or units inherent to the process, method, product, or device.

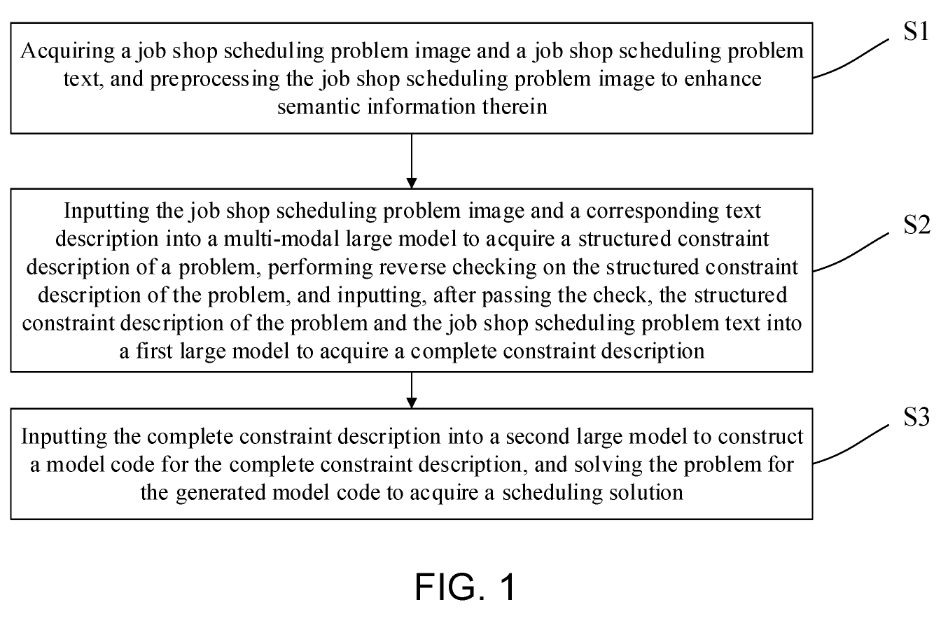

FIG. 1 is a schematic flowchart of a job shop scheduling optimization method driven by multi-modal large-model collaboration according to an embodiment of the present application. As shown in FIG. 1, the job shop scheduling optimization method driven by multi-modal large-model collaboration according to the embodiment of the present application includes the following steps.
In S1, a job shop scheduling problem image and a job shop scheduling problem text are acquired, and the job shop scheduling problem image is preprocessed to enhance the semantic information therein.
In S2, the job shop scheduling problem image and a corresponding text description are input into a multi-modal large model to acquire a structured constraint description of the problem, reverse checking is performed on the structured constraint description of the problem, and after passing the check, the structured constraint description of the problem and the job shop scheduling problem text are input into a first large model to acquire a complete constraint description.
In S3, the complete constraint description is input into a second large model to construct a model code for the complete constraint description, and the problem is solved for the generated model code to acquire a scheduling solution.

Specifically, a user inputs dual-modal information of the job shop scheduling problem image and the job shop scheduling problem text (a job shop constraint diagram and a basic problem description). The image includes constraint information about the job shop, such as time window constraints between special processes, and the textual information includes the user’s basic requirement description and a brief introduction to the image information. First, the constraint diagram is preprocessed to eliminate obvious adversarial disturbances and enhance the semantic information in the image.

The user can input a diagram by uploading pre-drawn image files (including JPG, PNG, etc.) via a computer or scanning hand-drawn paper process diagrams using a scanning apparatus in the scheduling optimization apparatus. If a structured constraint description cannot be provided in a standard manner, inputs can be provided by drawing diagrams such as a workpiece constraint relationship diagram, a job shop equipment distribution diagram, or a logic diagram for task allocation among parallel machines, supplemented with a small amount of textual description. These inputs will serve as the basis for the subsequent understanding and organization of structured job shop constraint information by the large model.

Assume a factory job shop needs to perform processing scheduling for a batch of parts, and a scheduler provides input information through the following methods: The scheduler uses a high-definition camera on the job shop site to capture a diagram containing sequential relationships of processes and time window constraints, and the image is uploaded to the system via a job shop scheduling optimization apparatus; the scheduler inputs a textual description in the system interface, specifying the types of workpieces that need to be processed preferentially and delivery time requirements.

Upon receiving the image and text, the system preprocesses the image by using perspective transformation technology to correct a geometric distortion in the image, thereby ensuring that the process relationship and a constraint marker are clearly discernible. The text region in the image is located using an EAST model, and the resolution of the text region is enhanced while removing the surrounding interference. A lightweight segmentation model, YOLO-Nano, is utilized to isolate key elements in the image, such as arrows and guide lines, followed by differentiated enhancement of these elements. After preprocessing, the semantic information in the image is strengthened, providing clearer input for subsequent constraint extraction.

A multi-modal large model can process various types of modality data (such as text, images, and audio). Through joint learning and representation, it achieves cross-modal understanding, generation, and interaction as an artificial intelligence model, aiming to process various types of modality data in a more comprehensive and intelligent manner. By utilizing a multi-modal large model to extract a structured constraint description and perform reverse checking, a preprocessed image is input into the multi-modal large model (e.g., Qwen2.5-VL). This model, fine-tuned with instructions from specialized corpora, is capable of accurately understanding complex constraints within the image. The model identifies a time window constraint between process O1 and process O2 in the image as “process O2 must begin within 1 hour after the completion of process O1”, as well as a sequential constraint indicating that process O3 must be completed prior to process O4. Reverse checking: The generated constraint description is input into a first large model (e.g., Qwen2.5-7B), and code for drawing a constraint diagram is generated and run to generate a constraint checking diagram. Comparing the generated constraint checking diagram with the original image reveals structural similarity and accurate information between the two, confirming the correctness of the constraint extraction.

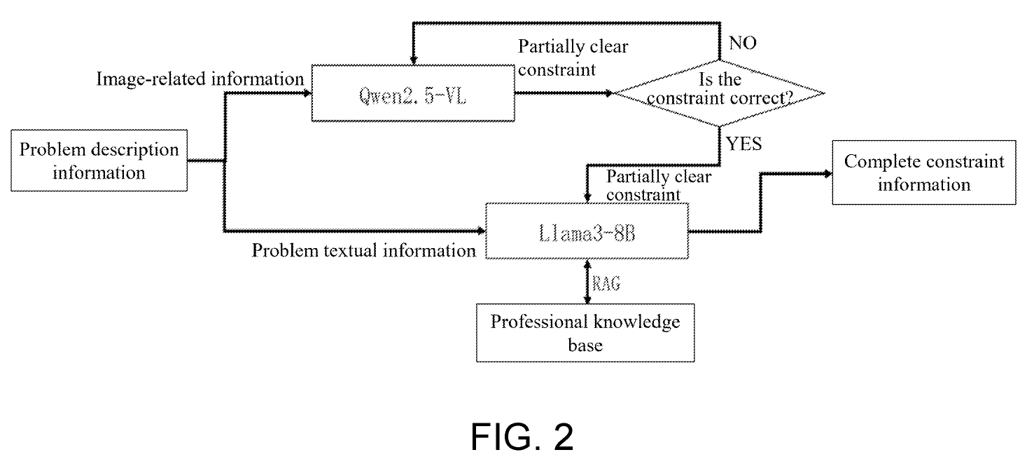

The multi-modal problem information on job shop scheduling is understood and segmented through a large model. Combined with prompt engineering techniques, image information is input into the large model to derive partially clear constraint descriptions of the problem and perform checking. The acquired constraints and the problem textual information are input into the large model to obtain a complete constraint description. As shown in FIG. 2, the process of acquiring the complete constraint description is explained below.

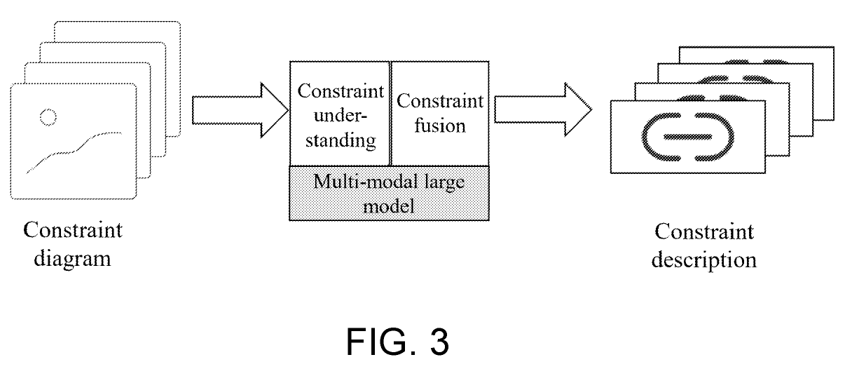

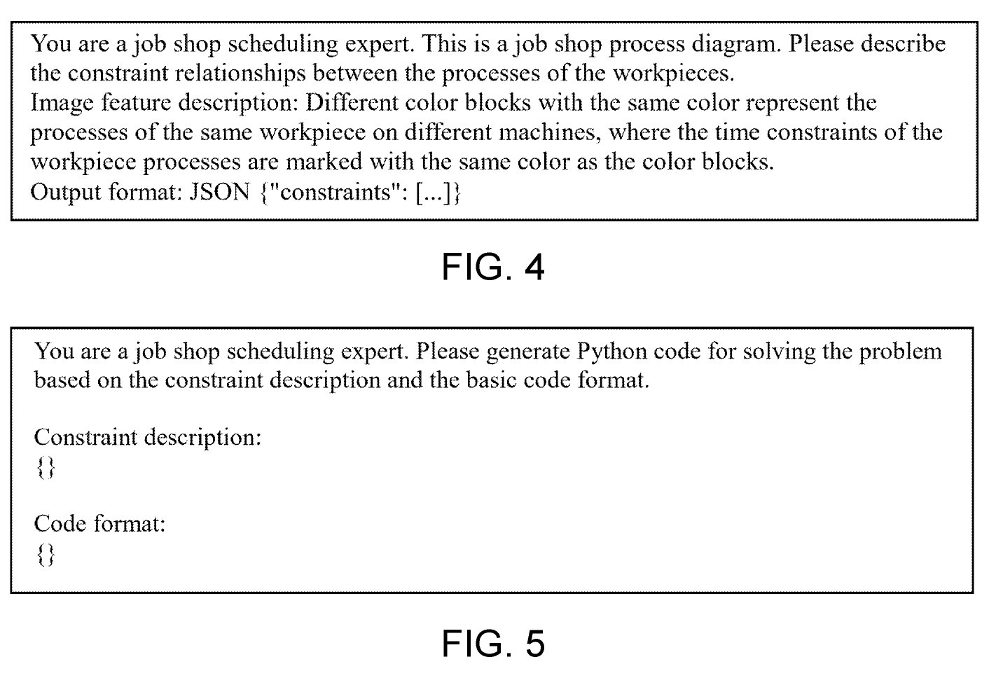

First, the multi-modal large model is utilized to preliminarily understand and segment the information. As shown in FIG. 3, all diagrams and basic introductions to the diagrams in the user-input information are input into the large model, and the model will perform two operations. The first operation is extracting constraints, such as extracting time window limitations between processes O11, O12, O21, and O22, completion time constraints between processes of workpieces 1 and 2, and processing times of workpieces by different grinding machines. As shown in FIG. 4, a prompt is used to guide the model to focus on specific regions to generate a standardized job shop constraint description.

The multi-modal large model can also be fine-tuned with instructions from specialized corpora. This enables the output of a structured constraint description for special constraint information reflected in the image. For example, based on the powerful image understanding capability and professional knowledge fine-tuning of the large model, combined with the diagram information, the multi-modal large model can clarify the complex constraint relationships in a real job shop. First, code is written to generate batches of image data with constraint annotations for various complex constraints in the job shop. Subsequently, a large model (e.g., GPT-4o) is used to generate batches of standardized textual description data of the constraints corresponding to the images. After filtering out unreasonable or semantically unclear textual description data, response data required for constructing an instruction fine-tuning dataset is obtained. A large model (e.g., deepseek-R1) is used to batch-generate different styles of instruction data that simulate user inputs. Finally, the images, textual description data corresponding to the images, and the instruction data are combined to obtain the instruction fine-tuning dataset.

The constraint descriptions that have passed the checking and the text descriptions input by the user are input into the first large model (e.g., LLama3-8B). By combining the priorities and delivery time requirements from the text, a complete constraint description is generated.

The second large model is used to generate model code and solve the scheduling solution. The complete constraint description is input into the second large model (e.g., Qwen2.5-Coder-7B), and in combination with the prompt engineering techniques, the model code for the scheduling problem is generated. The model generates Python code based on the constraint descriptions, invokes the Gurobi solver, and sets the objective function to minimize the completion time. The generated code is stored in program files and solved using actual data, such as the number of machines and workpieces provided by the factory. The solver computes based on the constraint condition and objective function in the code and ultimately generates a job shop scheduling solution that includes the allocation of processing tasks to each device and the arrangement of processing times.

According to the job shop scheduling optimization method driven by multi-modal large-model collaboration provided by the embodiments of the present application, the semantic information in images can be enhanced and the accuracy of constraint extraction can be improved through multi-modal information input and preprocessing. The collaborative processing of multi-modal large models can effectively generate clear and complete constraint descriptions while reducing constraint conflicts and redundancies. By using a multi-agent architecture and based on the division of labor and collaboration among different large models, efficient collaboration can be achieved, ranging from constraint generation to code construction and solution solving, thereby significantly improving the optimization efficiency and reliability of the scheduling solution. Meanwhile, the combination of reverse checking and a domain knowledge base verification mechanism can ensure the feasibility and global optimality of the scheduling solution.

Optionally, according to the job shop scheduling optimization method driven by multi-modal large-model collaboration provided by the embodiments of the present application, inputting the complete constraint description into the second large model to construct the model code for the complete constraint description, and solving the problem for the generated model code specifically includes:
inputting, based on a preset basic format requirement for code generation, the complete constraint description into the second large model to generate the model code, where the preset basic format requirement for code generation includes automatically selecting an objective function template based on a specified solver type and modeling language, function naming, and a variable definition method;
storing the generated model code into a preset program file, and preliminarily solving the model code based on preset job shop information and standardized data; and
automatically optimizing solver parameters by enabling parallel computation, a heuristic strategy, or by setting a time limit or a feasible solution threshold.

Specifically, for template-based code generation, as shown in FIG. 5, the prompt contains the basic format requirement for the desired generated code and the constraint description information extracted in the previous step. The format includes specifying the solver type (Gurobi) and modeling language (Python), function naming and variable definition methods, as well as automatically selecting the objective function template (minimizing completion time).

The prompt is input into the second large model (e.g., Qwen2.5-coder-7B) to generate scheduling problem-solving code, which is then stored in existing program files. One can opt to use information, such as the number of job shop machines and workpieces and process requirements, provided by users or standardized data pre-stored locally for preliminary problem-solving.

Automatic optimization of solver parameters suggests that the large model automatically adjusts solver parameters based on the scale of the problem (number of processes ≥ 50). For a large-scale problem, parallel computation (Threads = 4) and a heuristic strategy (MIPFocus = 3) are enabled. For a problem with a high real-time requirement, a time limit (TimeLimit = 300s) and a feasible solution threshold (MIPGap = 0.05) are set.

Optionally, according to the job shop scheduling optimization method driven by multi-modal large-model collaboration provided by the embodiments of the present application, after constructing the model code for the complete constraint description, the method further includes:
performing a feasibility check on the model code based on a third large model, providing, if the model code is unable to run properly, an error cause and a repair suggestion based on error information, inputting the error cause and the repair suggestion into the second large model, and reconstructing the model code for the complete constraint description until the model code runs properly.

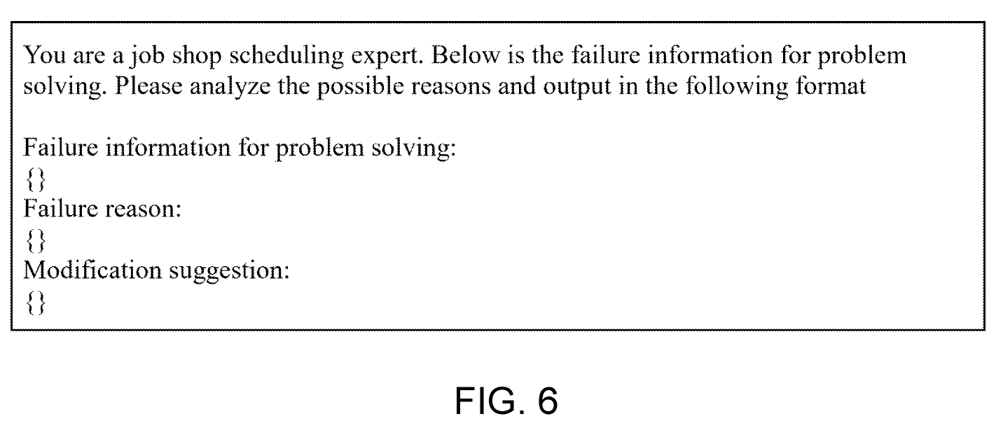

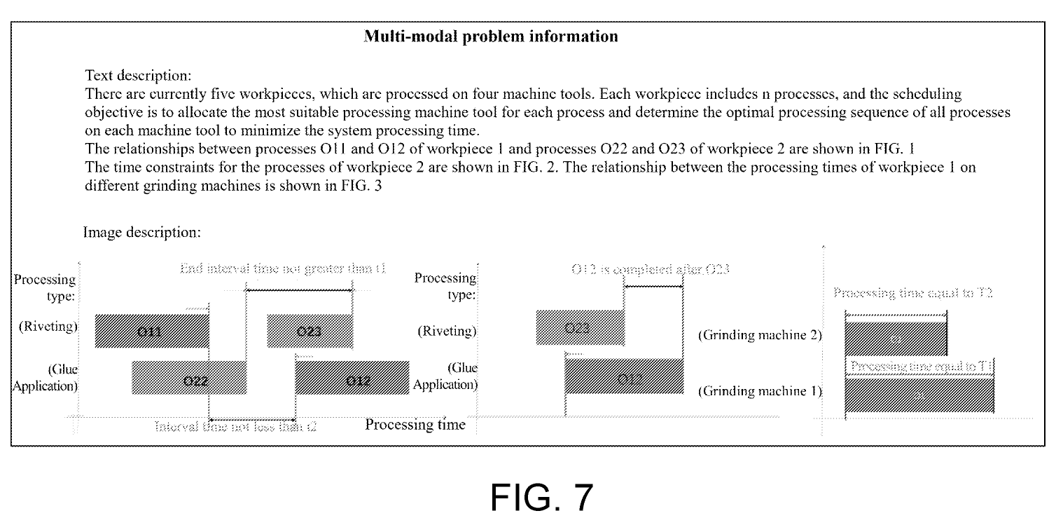

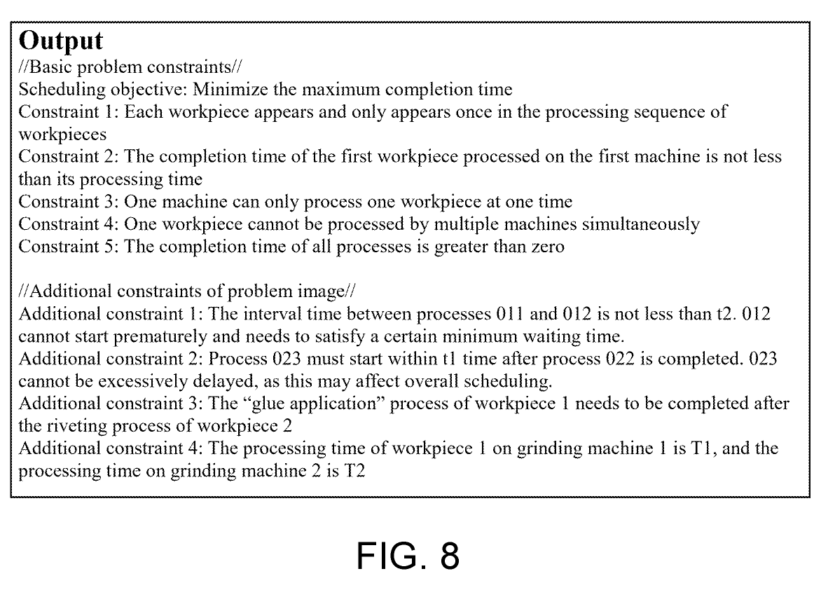

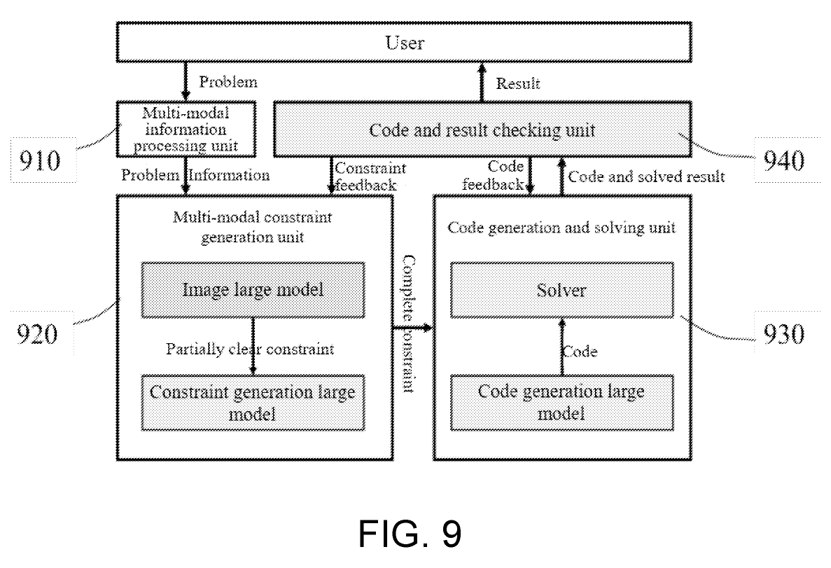

Specifically, feasibility checks and explanation generation are first conducted. As shown in FIG. 6, a third large model (e.g., Qwen2.5-coder-7B) is used to parse the solver logs and provide an error cause and a feedback suggestion based on the error information. The natural language reasoning capability of the large model is leveraged to solve error logs, such as “INFEASIBLE model”, to generate an interpretable repair suggestion report and return the report to the code generation phase, where the second large model regenerates executable code.

Optionally, according to the job shop scheduling optimization method driven by multi-modal large-model collaboration provided by the embodiments of the present application, after solving the problem for the generated model code, the method further includes:
inputting a solved result into a fourth large model for verification, performing reverse tracing for a detected anomaly to map an anomalous conflict node back to an original structured constraint description, locating a constraint logic flaw, optimizing constraint information, and reacquiring the structured constraint description of the problem.

Specifically, when the program can be run correctly, after the preliminary solving is completed, the system performs in-depth analysis and repair on the scheduling result by using a multi-dimensional verification mechanism. The raw data output by the solver (the JSON result from Gurobi) is parsed, and a fourth large model (such as Llama3-8B) is used in combination with a domain knowledge base to verify the physical meaning of the scheduling solution, for example, checking for hard constraint conflicts, such as whether process time windows are violated or whether the process deadlines are exceeded. For a detected anomaly, the system will trace backwards, mapping a conflict node (such as “the end time of process P5 on machine M2 exceeds its delivery deadline”) back to an original constraint description. By comparing with the structured constraint extracted in phase S1, the system locates a constraint logic flaw and prompts the multi-modal large model to optimize constraint information. For example, when detecting that resource competition leads to no solution, the feedback report may suggest “migrate process J7 from machine M3 to M5 and add a buffer time of 15 minutes” or “relax the priority of the precedence relationship constraint between processes J2 and J4”.

Optionally, according to the job shop scheduling optimization method driven by multi-modal large-model collaboration provided by the embodiments of the present application, preprocessing the job shop scheduling problem image specifically includes:
correcting the geometric shape of the acquired job shop scheduling problem image based on perspective transformation or thin-plate spline interpolation to restore a basic structure of the image;
locating a text region by using an EAST model, enhancing the resolution of a detected text region separately, and removing interference around the text through a binarization method or color masking; and
segmenting image regions based on a segmentation model, and performing differentiated enhancement on the segmented regions.

Specifically, the user inputs a diagram and the textual information containing the job shop scheduling problem constraint information. The image includes special constraint information, such as time window constraints between special processes (O11, O12, 022, 023). First, the constraint diagram is preprocessed to enhance the semantic information in the image and eliminate obvious adversarial disturbances. The specific workflow is as follows:

For example, when the user inputs the problem text description and the image description information as shown in FIG. 7, the textual information includes the user’s basic requirement description and a simple introduction to the image information. In the diagram, text, arrows, and special markers are used to represent some special constraints, such as the constraint relationships between gluing and riveting processes for certain workpieces 1 and 2 on aircraft wings.

Preprocessing the image primarily includes the following steps.

For distortion problems in scanned/photographed documents, perspective transformation or thin-plate spline interpolation is used to correct geometric shapes and restore the basic structure of the image.

Text regions are preprocessed by using the EAST model to locate the text regions. For a detected text region like “ending interval time not greater than t1” or “interval time not less than t2”, resolution is separately enhanced, and interference around the text is removed through a binarization method or color masking.

A lightweight segmentation model, YOLO-Nano, is used to isolate key elements in the diagram, such as arrows indicating relationships between two processes, guide lines, and text. Differentiated enhancement is applied to the segmented regions to make the indicative information in the image more obvious.

Using perspective transformation technology to adjust the image perspective, the coordinates of four key points in the image are calculated and mapped to convert an inclined plane into a front view, effectively correcting the geometric distortion of the document-like image. If the image contains nonlinear distortion or local deformation, thin-plate spline interpolation can be employed. This method achieves high-precision deformation correction by fitting a smooth surface, making it particularly suitable for the restoration of complex contours, while also avoiding edge blurring issues.

EAST treats text detection as a geometric regression problem rather than a traditional classification or segmentation task. Traditional methods (e.g., CTPN (connectionist text proposal network)) typically require multi-stage processing (such as candidate box generation and post-correction), whereas EAST directly predicts the geometric parameters of the text region (e.g., rotation angle, center point, width, and height), simplifying the process and reducing the complexity of post-processing.

Lightweight models (e.g., MobileNet-SSD, YOLO-Nano, or lightweight U-Net) significantly reduce computational complexity while ensuring segmentation precision, making them suitable for real-time processing requirements. After segmentation, a differentiated enhancement strategy is applied to optimize different categories of elements, such as enhancing the sharpness of arrows, maintaining the continuity of guide lines, or enhancing the contrast of text edges, thereby highlighting key information on the basis of an overall balanced image quality.

The purpose of preprocessing the image is to enhance useful information within the image. Since identification by a multi-modal large model can be easily affected by noise and unclear pixel information, reducing noise or other interferences, as well as enhancing textual, graphical, and specific marker information in the image, allows the model to extract features more effectively and accurately recognize key components within the image. Following these steps, job shop scheduling problem images with distinct regional differences and clear semantics are obtained.

Optionally, according to the job shop scheduling optimization method driven by multi-modal large-model collaboration provided by the embodiments of the present application, performing the reverse checking on the structured constraint description of the problem specifically includes:
inputting the structured constraint description of the problem into the multi-modal large model, generating code for drawing a job shop scheduling problem image based on the structured constraint description of the problem, running the code to acquire a new job shop scheduling problem image, comparing structural similarity and information accuracy between the job shop scheduling problem image and the new job shop scheduling problem image, initiating an incremental prompt adjustment based on a comparison result, adding a failure reason description to the structured constraint description of the problem, and re-inputting the structured constraint description into the multi-modal large model.

Specifically, reverse checking is performed based on the constraint description by inputting the generated constraint text, combined with a prompt, into a multi-modal large model (such as Qwen2.5-7b) to allow the multi-modal large model to generate code for drawing a constraint diagram, run the program to obtain a constraint checking diagram, and allow a user to compare the structural similarity and information accuracy between the generated diagram and the original diagram. If it does not align with the user’s intent, incremental prompt adjustment is initiated: reasons for failure, such as “the relationship between workpieces O21 and O22 was not detected”, are appended to the original prompt, iteratively optimizing constraint extraction.

The special constraint textual information that has passed the checking, along with the text description that is provided by the user in the first step and unrelated to the image, is input into the first model to comprehensively understand the user’s problem type and to organize all the structured constraint information of the user’s job shop scheduling problem. In one embodiment, all the generated structured constraint information is shown in FIG. 6.

Optionally, according to the job shop scheduling optimization method driven by multi-modal large-model collaboration provided by the embodiments of the present application, after preprocessing the job shop scheduling problem image, the method further includes:
when there are a plurality of job shop scheduling problem images, understanding the plurality of job shop scheduling problem images and corresponding text descriptions based on the multi-modal large model, identifying and removing redundant constraints and conflicting constraints, and then outputting a structured constraint description of the problem.

Specifically, when there are a plurality of constraint diagrams, the large model is used to remove redundant and conflicting constraints. The large model comprehends a plurality of diagrams and removes redundant constraints, such as scenarios where it is stipulated that process A has a higher priority than process B while simultaneously specifying that process B must start only after process A is completed. Since higher priority typically implies execution first, the subsequent sequence constraint becomes implied by the priority constraint. For conflicting constraints, such as Constraint 1 “process K must start within 1 hour after process L begins” and Constraint 2 “process L must start within 2 hours after process K begins”, the two time constraints cannot be satisfied simultaneously and thus result in conflicts. After the conflicts are identified and removed, a standardized job shop constraint description is output.

The embodiments of the present application further provide a job shop scheduling optimization apparatus driven by multi-modal large-model collaboration, which includes:
a multi-modal information processing unit, configured to acquire a job shop scheduling problem image and a job shop scheduling problem text and preprocess the job shop scheduling problem image to enhance semantic information therein;
a constraint generation unit, configured to input the job shop scheduling problem image and a corresponding text description into a multi-modal large model to acquire a structured constraint description of a problem, perform reverse checking on the structured constraint description of the problem, and input, after passing the check, the structured constraint description of the problem and the job shop scheduling problem text into a first large model to acquire a complete constraint description; and
a code generation and solving unit, configured to input the complete constraint description into a second large model to construct a model code for the complete constraint description and solve the problem for the generated model code to acquire a scheduling solution.

Specifically, as shown in FIG. 9, the multi-modal information processing unit 910 receives the multi-modal problem description information input by the user, which includes text, images, and the like. The multi-modal information processing unit 910 has image preprocessing capabilities. After receiving and processing the image information, the multi-modal information processing unit classifies the information from different modalities and then delegates the information to the corresponding large models for processing. For example, when the user inputs information containing a job shop process time constraint diagram and a production task description text through the system interaction interface, the multi-modal information processing unit 910 receives the information, invokes a program to preprocess the image, and then parses constraint descriptions such as production quantities and scheduling objectives from the text, as well as extracts information such as the sequential or parallel relationships of processes and time-window information from the image. The textual and image information is then passed to the constraint generation unit separately.

The constraint generation unit 920 performs constraint generation on the input multi-modal information by using a locally available open-source large model. Complex constraint information, such as time windows and the sequential relationships between processes, is extracted by using the multi-modal large model, thereby obtaining partially clear constraints. In addition, leveraging the language comprehension capability of large models, such as the LLmma3 large model combined with a knowledge base, a problem constraint description is generated based on the problem type described in the textual information. The problem constraint description is then merged with the aforementioned clear description to obtain complete and clear constraint information. For example, the Qwen2.5-VL analyzes the multi-modal information to extract a time window constraint that a certain process must be completed within a specific time period, as well as a sequential relationship between different processes. Meanwhile, the LLmma3-8B generates problem constraint descriptions such as device capacity limitations and material supply constraints based on the textual description of the production task type. These constraints are combined to form a complete constraint set.

The code generation and solving unit 930 is configured with the fine-tuned local code generation large model Qwen2.5-coder-7B. The code generation and solving unit generates the required code based on the constraint description output in S1. For example, the code generation large model generates Python code based on the constraint description, invokes a solver library, sets solver parameters, and executes the code; the solver performs calculation based on the constraint condition and objective function in the code, producing a job shop scheduling solution such as the allocation of processing tasks to each device, the arrangement of processing times, and other results.

The code and result checking unit 940 is configured with the Qwen2.5-coder-7B and Llama3-8B large models. The code and result checking unit checks the generated code and result based on the code output from the code generation and solving unit 930 and provides correction information. For example, during the check of the generated code, Qwen2.5-coder identifies an issue of incorrect variable definition or a logical reasoning error and provides a prompt. Alternatively, Llama3-8B, which is equipped with a knowledge base, compares the generated scheduling result with historical production data, actual device capacity, and so on, to verify whether the scheduling result satisfies the actual production requirement, such as whether device load is balanced or whether a delivery deadline is met. If not satisfied, return to the adjustment suggestion.

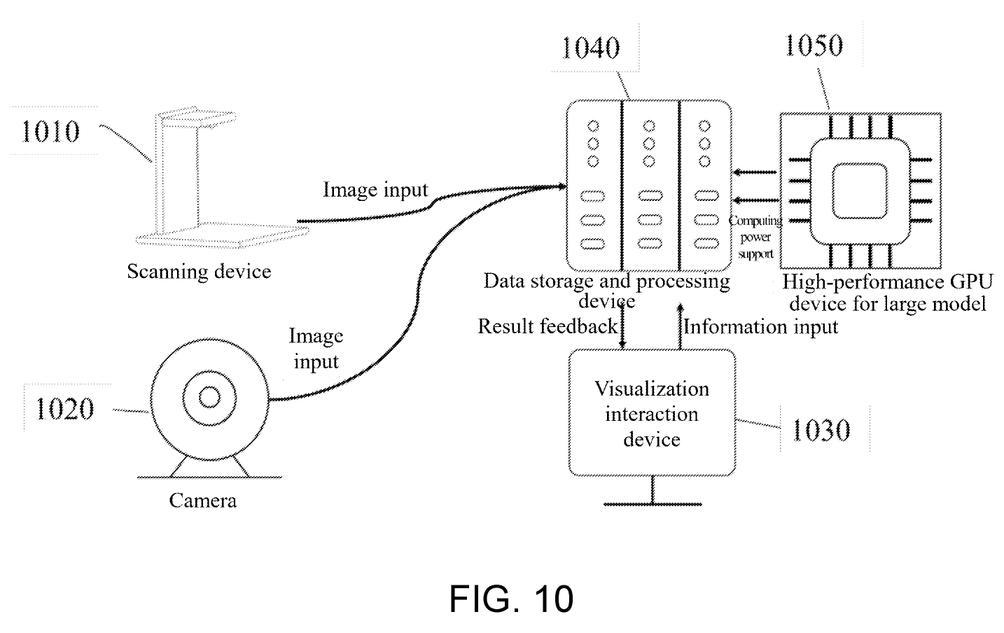

The present application further provides a job shop scheduling optimization system driven by multi-modal large-model collaboration. As shown in FIG. 10, the system is primarily composed of three main parts: image input devices 1010 and 1020; a data information storage and processing device 1040; a high-performance GPU device for large model processing 1050; and a visualization interaction device 1030. The image input devices 1010 and 1020 are configured to collect image information that characterizes a user intention and support scanning and inputting an image from the job shop site. The image input devices may be image scanning apparatuses, such as 1010 or the high-definition camera 1020, installed at key positions within the job shop, which establish communication connections with the data information storage and processing device via wired or wireless methods.

The data information storage and processing device 1040 is in communication connection with the image input devices 1010 and 1020 and is responsible for the critical task of integrating visual modality and text modality information. The data information storage and processing device internally stores executable program code and a processor and can analyze, process, and store the input multi-modal information. The device may be a high-performance industrial computer, equipped with powerful data processing capabilities and large storage capacity to meet the requirements of complex information processing in a job shop.

The high-performance GPU device for large model processing serves as computational power support, providing the computing power support required for all inference, fine-tuning, and training phases using large models mentioned in the methods.

The visualization interaction device 1030 supports the uploading of multi-modal information of a user problem. Meanwhile, the visualization interaction device can display codes collaboratively generated by multiple agents, constraint information, scheduling solutions, and the like. In practical operations, an operator can directly drag process blocks or modify time parameters through the interface of the device. The system will automatically convert these modifications into new constraint conditions and trigger incremental solving, which means re-optimizing only the subproblem of the affected process. This device may be a large touch display screen in the job shop, providing convenience for the operator to perform intuitive interactive operations.

The overall workflow of the system is as follows: The image input devices 1010 and 1020 collect image information of a job shop site and transmit the image information to the data information storage and processing device 1040. Meanwhile, other text modality information is also input into the device for integrated processing. The processed result is transmitted to the visualization interaction device 1030 for the operator to view and operate. An adjustment made by the operator through the visualization interaction device 1030 is fed back to the data information storage and processing device for a new round of optimization calculations, thereby achieving continuous optimization of job shop scheduling.

The core processing function of this job shop scheduling optimization system driven by multi-modal large-model collaboration is primarily executed by the data information storage and processing device 1040, while the image input devices 1010 and 1020 and the visualization interaction device 1030 serve as front-end devices for information collection and interactive display, together forming a complete job shop scheduling optimization system.

In practical application scenarios, a plurality of image input devices 1010 and 1020, visualization interaction devices 1030, performance-compatible data information storage and processing devices 1040, and high-performance GPU devices 1050 can be flexibly configured according to the scale and requirements of the job shop to achieve an optimal scheduling optimization effect.

The present application further provides a computer-readable storage medium having a computer program stored thereon. The program, when run by a processor, causes the processor to implement the steps of the method described above. The computer-readable storage medium may include, but is not limited to, any type of disk, including a floppy disk, an optical disk, a DVD, a CD-ROM, a miniature drive, a magneto-optical disk, a read-only memory (ROM), a random access memory (RAM), an erasable programmable ROM (EPROM), an electrically-erasable programmable ROM (EEPROM), a dynamic random-access memory (DRAM), a video RAM (VRAM), a flash memory device, a magnetic card or optical card, a nanosystem (including a molecular memory IC), or any type of medium or device suitable for storing instructions and/or data.

It should be noted that for ease of description, each of the aforementioned embodiments is expressed as a series of combinations of actions, but those skilled in the art should recognize that the present application is not limited by the described action order, as certain steps may be performed in other orders or simultaneously according to the present application. Then, those skilled in the art should recognize that the embodiments described in this specification are all preferred embodiments, and the actions and units involved are not necessarily required in the present application.

In the above embodiments, the description of each embodiment has its respective focus. For a part that is not described in detail in an embodiment, reference can be made to related descriptions in other embodiments.

In the several embodiments provided in the present application, it should be understood that the disclosed apparatus may be implemented in other manners. For example, the apparatus embodiments described above are merely illustrative. The division of the units, for example, is simply a logical functional division, and in actual implementation, there may be other division methods. For example, a plurality of units or components may be combined or integrated into another system, or certain features may be omitted or not executed. Additionally, the coupling, direct coupling, or communication connections shown or discussed between components may be indirect coupling or communication connections achieved through certain service interfaces, apparatuses, or units, and may be electrical or other forms of connections.

The units described as separate parts may or may not be physically separate, and parts displayed as units may or may not be physical units, that is, they may be located in one place or distributed across a plurality of network units. Some or all of the units may be selected according to actual needs to achieve the purpose of the solutions of the embodiments.

In addition, various functional units in the embodiments of the present application may be integrated into one processing unit, or various units may be physically present separately, or two or more units may be integrated into one unit. The integrated unit may be implemented in the form of hardware or in the form of a software functional unit.

The integrated unit may be stored in a computer-readable memory if it is implemented in the form of a software functional unit and sold or used as an independent product. Based on such understandings, the technical solutions of the present application, essentially, or the parts contributing to the prior art, or the entirety or part of the technical solutions, may be embodied in the form of a software product. The computer software product is stored in a memory and includes several instructions for causing a computer device (which may be a personal computer, a server, or a network device) to perform all or part of the steps of the methods as defined in the embodiments of the present application. The aforementioned memory includes various media capable of storing program code, such as a universal serial bus (USB) drive, a ROM, a RAM, a portable hard drive, a magnetic disk, or an optical disk.

Those of ordinary skill in the art should understand that all or some of the steps in the various methods of the above embodiments can be completed by instructing relevant hardware through a program. The program may be stored in a computer-readable memory, and the memory may include: a flash disk, a ROM, a RAM, a magnetic disk, an optical disk, or the like.

The present disclosure can significantly enhance the accuracy, efficiency, and reliability of job shop scheduling while reducing the usage threshold.

The above descriptions are merely exemplary embodiments of the present disclosure and are not intended to limit the scope of the present disclosure. That is, all equivalent changes and modifications made in accordance with the teachings of the present disclosure are still within the scope of the present disclosure. Other embodiments of the present disclosure are apparent to those skilled in the art from consideration of the specification and practice of the present disclosure. The present application is intended to cover any variations, uses, or adaptations of the present disclosure following the general principles of the present disclosure and including known common knowledge or customary technical means not described in the art of the present disclosure. The specification and embodiments are only considered as exemplary, and the scope and spirit of the present disclosure are defined by the claims.

The technical features of the above embodiments may be arbitrarily combined. For the sake of a concise description, not all possible combinations of the technical features in the above embodiments have been described. However, as long as there is no contradiction between the combinations of these technical features, they should be considered as falling within the scope of the specification.

Those skilled in the art will readily understand that the above descriptions are merely preferred embodiments of the present disclosure and are not intended to limit the present disclosure. Any modifications, equivalents, improvements, and the like made within the spirit and principle of the present disclosure shall fall within the protection scope of the present disclosure.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A job shop scheduling optimization method driven by multi-modal large-model collaboration, comprising following steps:
acquiring a job shop scheduling problem image and a job shop scheduling problem text, and preprocessing the job shop scheduling problem image to enhance semantic information therein;
inputting the job shop scheduling problem image and a corresponding text description into a multi-modal large model to acquire a structured constraint description of a problem, performing reverse checking on the structured constraint description of the problem, and inputting, after passing check, the structured constraint description of the problem and the job shop scheduling problem text into a first large model to acquire a complete constraint description; and
inputting the complete constraint description into a second large model to construct a model code for the complete constraint description, and solving a problem for the model code which is generated to acquire a scheduling solution.

2. The job shop scheduling optimization method driven by multi-modal large-model collaboration according to claim 1, wherein inputting the complete constraint description into the second large model to construct the model code for the complete constraint description, and solving the problem for the model code which is generated specifically comprises:
inputting, based on a preset basic format requirement for code generation, the complete constraint description into the second large model to generate the model code, wherein the preset basic format requirement for code generation comprises automatically selecting an objective function template based on a specified solver type and modeling language, function naming, and a variable definition method;
storing the model code which is generated into a preset program file, and preliminarily solving the model code based on preset job shop information and standardized data; and
automatically optimizing solver parameters by enabling parallel computation, a heuristic strategy, or by setting a time limit or a feasible solution threshold.

3. The job shop scheduling optimization method driven by multi-modal large-model collaboration according to claim 1, wherein after constructing the model code for the complete constraint description, the method further comprises:
performing a feasibility check on the model code based on a third large model, providing, if the model code is unable to run properly, an error cause and a repair suggestion based on error information, inputting the error cause and the repair suggestion into the second large model, and reconstructing the model code for the complete constraint description until the model code runs properly.

4. The job shop scheduling optimization method driven by multi-modal large-model collaboration according to claim 1, wherein after solving the problem for the model code which is generated, the method further comprises:
inputting a solved result into a fourth large model for verification, performing reverse tracing for a detected anomaly to map an anomalous conflict node back to an original structured constraint description, locating a constraint logic flaw, optimizing constraint information, and reacquiring the structured constraint description of the problem.

5. The job shop scheduling optimization method driven by multi-modal large-model collaboration according to claim 1, wherein preprocessing the job shop scheduling problem image specifically comprises:
correcting a geometric shape of the acquired job shop scheduling problem image based on perspective transformation or thin-plate spline interpolation to restore a basic structure of the job shop scheduling problem image;
locating a text region by using an efficient and accurate scene text detector (EAST) model, enhancing resolution of a text region which is detected separately, and removing interference around text through a binarization method or color masking; and
segmenting image regions based on a segmentation model, and performing differentiated enhancement on segmented regions.

6. The job shop scheduling optimization method driven by multi-modal large-model collaboration according to claim 1, wherein performing the reverse checking on the structured constraint description of the problem specifically comprises:
inputting the structured constraint description of the problem into the multi-modal large model, generating code for drawing the job shop scheduling problem image based on the structured constraint description of the problem, running the code to acquire a new job shop scheduling problem image, comparing structural similarity and information accuracy between the job shop scheduling problem image and the new job shop scheduling problem image, initiating an incremental prompt adjustment based on a comparison result, adding a failure reason description to the structured constraint description of the problem, and re-inputting the structured constraint description into the multi-modal large model.

7. The job shop scheduling optimization method driven by multi-modal large-model collaboration according to claim 1, wherein after preprocessing the job shop scheduling problem image, the method further comprises:
when there are a plurality of job shop scheduling problem images, understanding the plurality of job shop scheduling problem images and corresponding text descriptions based on the multi-modal large model, identifying and removing redundant constraints and conflicting constraints, and then outputting a structured constraint description of the problem.

8. A job shop scheduling optimization apparatus driven by multi-modal large-model collaboration, comprising:
a multi-modal information processing unit, configured to acquire a job shop scheduling problem image and a job shop scheduling problem text, and preprocess the job shop scheduling problem image to enhance semantic information therein;
a constraint generation unit, configured to input the job shop scheduling problem image and a corresponding text description into a multi-modal large model to acquire a structured constraint description of a problem, perform reverse checking on the structured constraint description of the problem, and input, after passing check, the structured constraint description of the problem and the job shop scheduling problem text into a first large model to acquire a complete constraint description; and
a code generation and solving unit, configured to input the complete constraint description into a second large model to construct a model code for the complete constraint description, and solve a problem for the model code which is generated to acquire a scheduling solution.

9. A job shop scheduling optimization device driven by multi-modal large-model collaboration, comprising at least one processing unit and at least one storage unit, wherein the storage unit stores a computer program, and the computer program, when run by the processing unit, causes the processing unit to perform the steps of the method according to claim 1.
